(19) United States
(12) Patent Application Publication
(10) Pub. No.: US 2008/0120601 A1
(43) Pub. Date: May 22, 2008

(54) INFORMATION PROCESSING APPARATUS, METHOD AND PROGRAM FOR DECIDING PRIORITY OF TEST CASE TO BE CARRIED OUT IN REGRESSION TEST BACKGROUND OF THE INVENTION

(76) Inventors: Takashi Ashida, Yamato-shi (JP); Tomomi Inoue, Tokyo (JP)

Correspondence Address: INTERNATIONAL BUSINESS MACHINES CORPORATION, 650 Harry Road, L2PA/J2C, INTELLECTUAL PROPERTY LAW, SAN JOSE, CA, 95120-6099, US

(21) Appl. No.: 11/873,287

(22) Filed: Oct. 16, 2007

(30) Foreign Application Priority Data
Nov. 16, 2006 (JP) 2006-310711

(51) Int. Cl. G06F 11/36; G06F 9/44

(52) U.S. Cl. 717/124

(57) ABSTRACT

An information processing apparatus and method is provided. A storage part is provided for storing a revision history table that associates each of a plurality of first revision identifiers. One or more first function identifiers that identify the function revised in the past revision identified by the associated revision identifier and included in a program. An acquisition part for acquiring one or more second function identifiers that identify the function revised in the new revision and included in the program. A priority decision part for obtaining the number of matched function identifiers between one or more first function identifiers associated with the first revision identifier and the second function identifiers for each of the first revision identifiers in the revision history table read from the storage part. Deciding the priority of the test case for testing the revision identified by each first revision identifier, based on the number of matched function identifiers.

### BACKGROUND OF THE INVENTION

1. Field of the Invention

The present invention relates to selection of a test case to be carried out in a regression test of a program, and more particularly to a technique for deciding the priorities of the test cases where there are two or more test cases to be carried out.

2. Background Information

In making a change to a program for function expansion or problem revision, a regression test is commonly carried out to check whether or not a new problem arises due to the change. In the regression test, the change is confirmed and test cases already carried out in the past are carried out again. However, if all the test cases in the past are carried out every time the change is made, an enormous number of man-hours are required. Thus, it has become common practice to select some test cases from among the test cases carried out in the past to reduce the number of man-hours.

As the prior art for selecting some test cases from among the test cases carried out in the past, there is US Patent Publication No.: 2003-91431. Disclosed therein is a technique that in making a revision to each source file comprising a program, a correspondence table showing the correspondence between the revision ID of specifying the revision, the source file names of a revised source files and the test case used for testing the source file is created, and when the program is changed, the test cases associated with the changed source file are selected and re-executed.

With the disclosed technique, a list of test cases associated with the changed source file is provided, but the information concerning the priority of each listed test case is not provided. Therefore, the program developer can not judge which test case is more likely to cause an error among the listed test cases, and discover the new problem due to the change efficiently.

Thus, to solve this problem, a technique for deciding the priorities of test cases to be carried out has been developed. For example, US Patent Publication No.: 2004-5399, discloses a technique where the number of revisions in each state of the software operating while transiting between plural states is stored as development history information, and a plurality of test cases for testing the software by connecting the states with trigger are created in which each test case is weighted using the development history information. Also, disclosed is another technique that each test case is weighted according to the presence or absence of track record on the real machine, and another technique that each test case is weighted according to the pass/fail result of carrying out the test case.

Thus, it is an object of the invention to provide an information processing apparatus, method and program for extracting the test cases to be newly carried out due to the revision of program, as well as deciding the priority of each of the extracted test cases, indicating the probability of causing an error again, from the relationship with the new revision in a regression test of program.

### SUMMARY OF THE INVENTION

One general embodiment of the invention is implemented by a method for deciding the priority of a test case to be carried out in a regression test of a program, which is carried out in an information processing apparatus as in the following manner. Herein, the program includes one or more functions. A revision history table that associates each of a plurality of first revision identifiers, which identifies the past revision, with one or more first function identifiers each of which identifies the function revised in the past revision identified by the associated first revision identifier is read from a storage part of the information processing apparatus. One or more second function identifiers each of which identifies the function revised in the new revision are acquired. The number of matched function identifiers between the one or more first function identifiers associated with the first revision identifier and the acquired one or more second function identifiers is obtained for each first revision identifiers in the revision history table. The priority of the test case for testing the past revision identified by each first revision identifier is obtained, based on the number of matched function identifiers that is obtained for each first revision identifier in the revision history table.

If the function already revised in the past is revised, the past test case for testing the past revision is likely to cause an error again due to new revision. As the number of matched functions between plural functions revised in the new revision and plural functions revised in the past revision is larger, the possibility that the past test case for testing the past revision causes an error again is increased due to the new revision. Thus, the degree of overlap between the functions revised in the new revision and the functions revised in the past revision is defined as the priority of the past test case for testing the past revision. The typical term function means a group of instructions to receive data called the argument perform a certain process and return the result. However, the functions in this invention include the function without argument and the function returning no result.

In the method, each second function identifier may be directly acquired via an input part of the information processing apparatus from the user. Instead, only a second revision identifier for identifying the new revision may be accepted via the input part of the information processing apparatus from the user. In this case, a source code of the program in a version associated with the second revision identifier is obtained by referring to a correspondence table that associates the revision identifier for identifying the revision and the version of the program revised in the revision. Each second function identifier is acquired by comparing the source code of the program in the current version and the source code of the program in the previous version and detecting the unmatched function.

Preferably, in obtaining the number of matched function identifiers, each matched function identified by the matched function identifiers is weighted by determining whether or not a reviser of each matched function is different between the new revision and the past revision. The number of matched function identifiers is obtained in consideration of the weighted result. More specifically, the matched function of which the reviser is different between the new revision and the past revision is more heavily weighted than the matched function of which the reviser is not different.

If the function already revised in the past is revised, the past test case for testing the past revision is likely to cause an error again due to new revision, as described above. However, if the past revision is made by oneself, such possibility is lower than that in the case where the past revision is made by others. Thus, the matched function is weighted depending on whether or not the reviser making the new revision and the reviser making the past revision are identical.

Also, in obtaining the number of matched function identifiers, each matched function identified by the matched function identifiers is weighted according to the amount of revision due to new revision for the matched function. The number of matched function identifiers is obtained in consideration of the weighted result. More specifically, the matched function for which the amount of revision due to new revision is large is more heavily weighted than the matched function for which the amount of revision is small.

If the function already revised in the past is revised, the past test case for testing the past revision is likely to cause an error again due to new revision, as described above. However, if the amount of revision due to new revision is small, the possibility that the past test case for testing the past revision causes an error again in the new revision is low, even though the same function was revised in the past. Thus, the matched function is weighted according to the amount of revision due to new revision.

In obtaining the number of matched function identifiers, each matched function identified by the matched function identifiers is weighted according to the number of past revision for the matched function. The number of matched function identifiers is obtained in consideration of the weighted result. More specifically, the matched function for which the number of past revisions is large is more heavily weighted than the matched function for which the number of the past revisions is small.

If the function already revised in the past is revised, the past test case for testing the past revision is likely to cause an error again due to new revision, as described above. The possibility of causing an error is increased as the number of times the function is revised in the past is larger. Thus, the matched function is weighted according to the number of past revisions.

The above method further comprises outputting a list of first revision identifiers in which the first revision identifiers are arranged in the decided order of priority via an output part of the information processing apparatus.

### BRIEF DESCRIPTION OF THE DRAWINGS

FIG. 1 shows one example of the functional configuration of an information processing apparatus 100 for deciding the priority of a test case to be carried out according to one embodiment of the present invention;

FIG. 2A shows one example of new revision associated data 235, and FIG. 2B shows one example of a version correspondence table 260;

FIG. 3A shows one example of a revision history table 240, and FIG. 3B shows one example of a revision history table 240 after update;

FIG. 4A shows one example of new revision associated data 235, and FIG. 4B shows one example of the revision history table 240 with the priority added;

FIG. 5A shows one example of new revision associated data 235, and FIG. 5B shows one example of the revision history table 240 including the priority in consideration of the weighted result by the reviser;

FIG. 6A shows one example of new revision associated data 235, and FIG. 6B shows one example of the first function risk table 245;

FIG. 7A shows one example of new revision associated data 235, and FIG. 7B shows one example of the second function risk table 250;

FIG. 8A shows one example of new revision associated data 235, FIG. 8B shows one example of the first function risk table 245, and FIG. 8C shows one example of the revision history table 240 including the priority in consideration of the weighted result by the amount of revision;

FIG. 9 is a flowchart showing one example of processing flow for acquiring new revision associated data 235;

FIG. 10 is a flowchart showing one example of processing flow for creating or updating the revision history table 240;

FIG. 11 is a flowchart showing one example of processing flow for deciding the priority;

FIG. 12 is a flowchart showing one example of processing flow for deciding the priority in consideration of the weighted result by the reviser;

FIG. 13 is a flowchart showing one example of processing flow for creating the first function risk table 245;

FIG. 14 is a flowchart showing one example of processing flow for creating the second function risk table 250;

FIG. 15 is a flowchart showing one example of processing flow for deciding the priority in consideration of the weighted result by the amount of revision;

FIG. 16A shows one example of the dialogbox of a new revision list, and FIG. 16B shows one example of the dialog box of a past revision ID list associated with the revision ID “9003”; and

FIG. 17 shows one example of the hardware configuration of the information processing apparatus 100 according to the embodiment of the invention.

### DESCRIPTION OF THE PREFERRED EMBODIMENTS

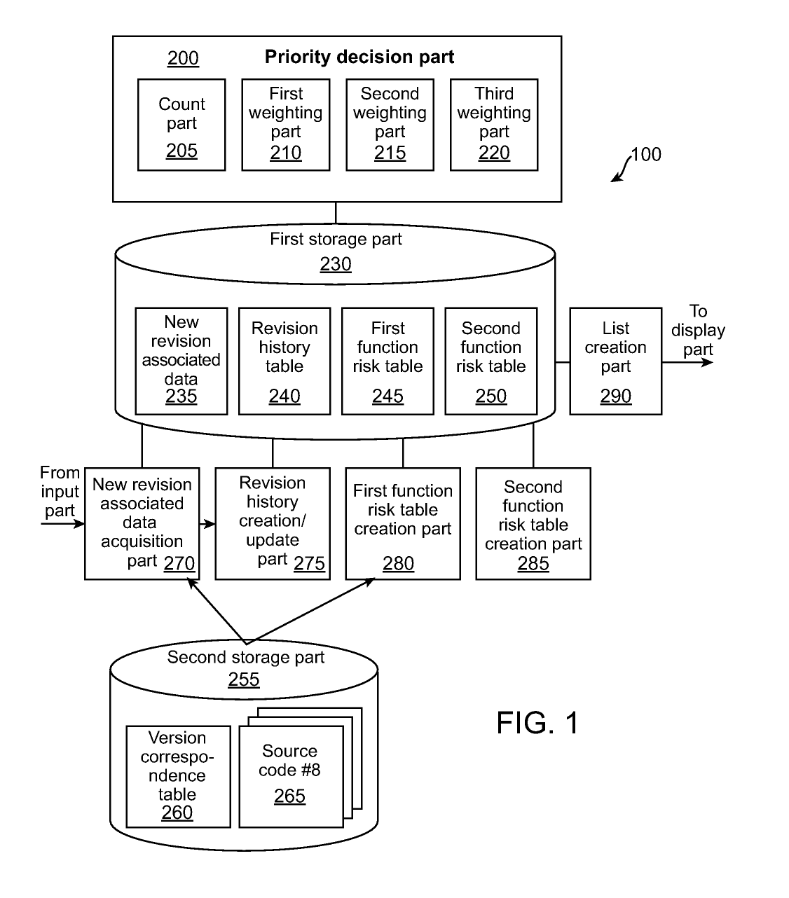

FIG. 1 shows one general embodiment of the functional configuration of an information processing apparatus 100 for deciding the priority of a test case to be carried out in a regression test of program. The information processing apparatus 100 comprises a priority decision part 200, a first storage part 230 that stores new revision associated data 235, a revision history table 240, a first function risk table 245 and a second function risk table 250, and a second storage part 255 that stores a version correspondence table 260 and a source code 265 of program in each version. The priority decision part 200 has a function of deciding the priority of the test case, and comprises a count part 205, a first weighting part 210, a second weighting part 215 and a third weighting part 220.

The information processing apparatus 100 further comprises a new revision associated data acquisition part 270, a revision history creation/update part 275, a first function risk table creation part 280, a second function risk table creation part 285, and a list creation/output part 290. The first storage part 230 and the second storage part 255 may be the physically same storage unit.

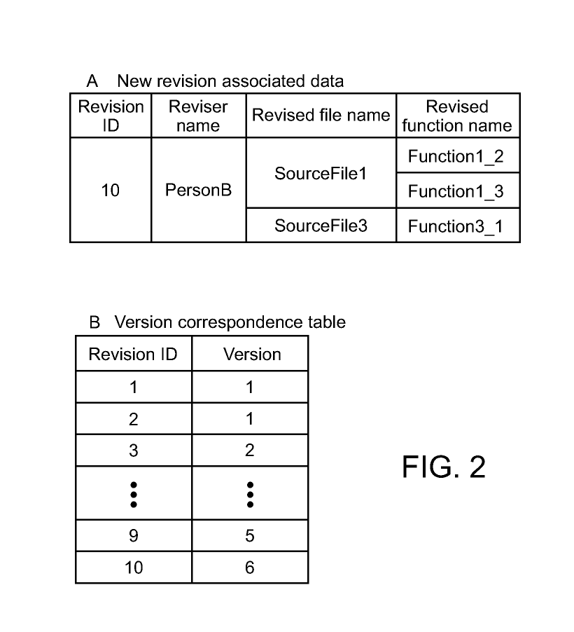

The new revision associated data 235 is data concerning the new revision newly made to the program. As one example, the new revision associated data 235 includes a revision identifier of specifying the new revision owing to a revision factor such as problem revision or function addition and a function identifier of specifying the newly revised function, and may further,include a file identifier of specifying the file containing the newly revised function, and a reviser identifier of specifying the reviser making the new revision. In this embodiment, the program may be composed of two or more files. FIG. 2A shows one example of new revision associated data 235. In this embodiment, the revision identifier is a revision ID, the function identifier is a function name, the reviser identifier is a reviser name, and the file identifier is a file name, as shown in FIG. 2A.

The version correspondence table 260 is the table associating the revision ID of specifying the revision made to the program and the version of program to which the revision is made. FIG. 2B shows one example of the version correspondence table 260. The version correspondence table 260 may be created manually or using a source code management tool, commercially available on the market. For example, in a, Rational (registered trademark by IBM) ClearCase (registered trademark by IBM) source code management tool available from International Business Machines (IBM, IBM is registered trademark), if a new revision is made to the program, the revision ID is automatically assigned to the revision, and stored and managed associated with the version of revised program. The second storage part 255 that stores the version correspondence table 260 also stores the source code 265 itself of the program in each version in this embodiment.

The new revision associated data acquisition part 270 acquires new revision associated data 235 and temporarily stores the acquired new revision associated data 235 in the first storage part 230, when a new revision is made to the program. Herein, temporarily storing means probably deleting data after being used by the count part 205 as will be described later or used to update the revision history table 240. The new revision associated data acquisition part 270 acquires new revision associated data 235 from the user via an input part of the information processing apparatus 100 as one example.

The new revision associated data acquisition part 270 may acquire the new revision ID of specifying the new revision from the user via the input part of the information processing apparatus 100. In this case, the new revision associated data acquisition part 270 obtains the version of program corresponding to the new revision ID by referring to the version correspondence table 260. And the new revision associated data 235 is acquired by comparing the source code of program in the concerned version and the source code of program in the previous version of the concerned version and detecting one or more functions in which they are unmatched.

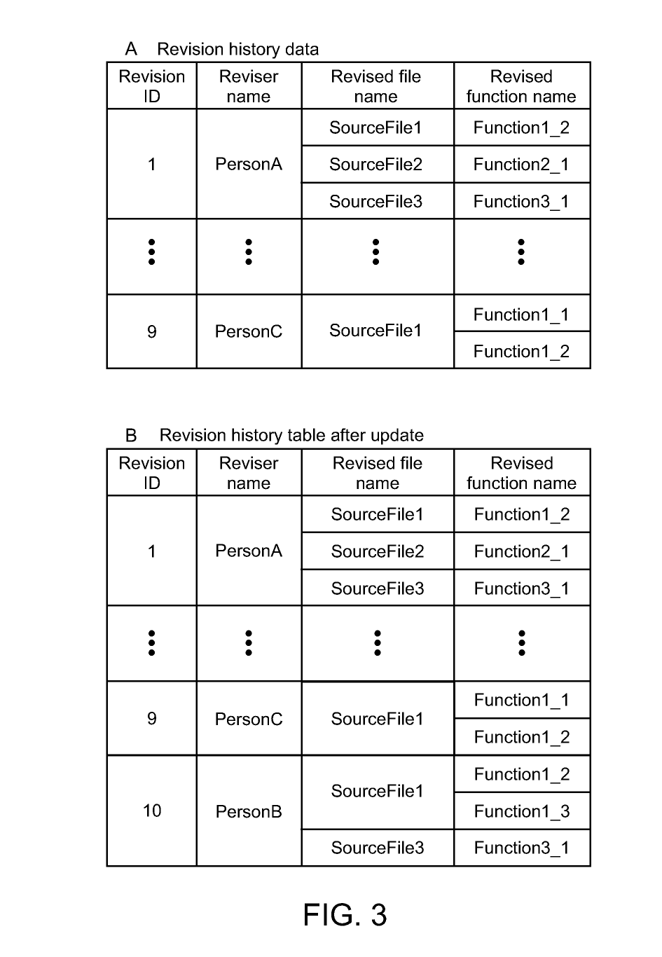

The revision history table 240 is the table that organizes data concerning the past revisions made to the program. As one example, the revision history table 240 associates each of plurality of the revision IDs, which identifies the past revision, with one or more function names each of which identifies the revised function in the concerned revision, and may further associate it with the reviser name and the file name of the file including the function to which the revision is made. FIG. 3A shows one example of the revision history table 240. As will be apparent from FIG. 3A, one entry of the revision history table 240 is the new revision associated data 235 in the past.

The revision history creation/update part 275 creates the revision history table 240, and updates the revision history table 240 if the new revision is made to the program. The revision history creation/update part 275 updates the revision history table 240 by adding new revision associated data 235 to the revision history table 240 (see FIG. 2A and FIGS. 3A and 3B). Herein, an example of revision specified by the revision ID will be described below. For example, the revision specified by the revision ID “1” of FIG. 3 is correction for spelling error to correct a misspelled character described as the character displayed on the screen in Function1_2, Function2_1 and Function3_1. Also, the revision specified by the revision ID “9” of FIG. 3 is revision for the number of loops to revise the number of times through the loop in Function1_1 and Function1_2.

The count part 205 reads the new revision associated data 235 and the revision history table 240 from the first storage part 230, compares one or more function names associated with the concerned revision ID and one or more function names within the new revision associated data 235 for each revision ID of the revision history table 240, and counts the number of the function names in which they are matched. Each counted number is added to the revision history table 240 by the priority decision part 200 as the priority of test case to test the revision of the corresponding revision ID.

This method for deciding the priority of the past test case is based on the following inference. That is, the inference is that if the function already revised in the past is revised, the past test case for testing the past revision is likely to cause an error again due to new revision. This inference is that plural functions to be newly revised and plural functions revised in the past revision are more matched, the test case for testing the past revision is more likely to cause an error again due to new revision.

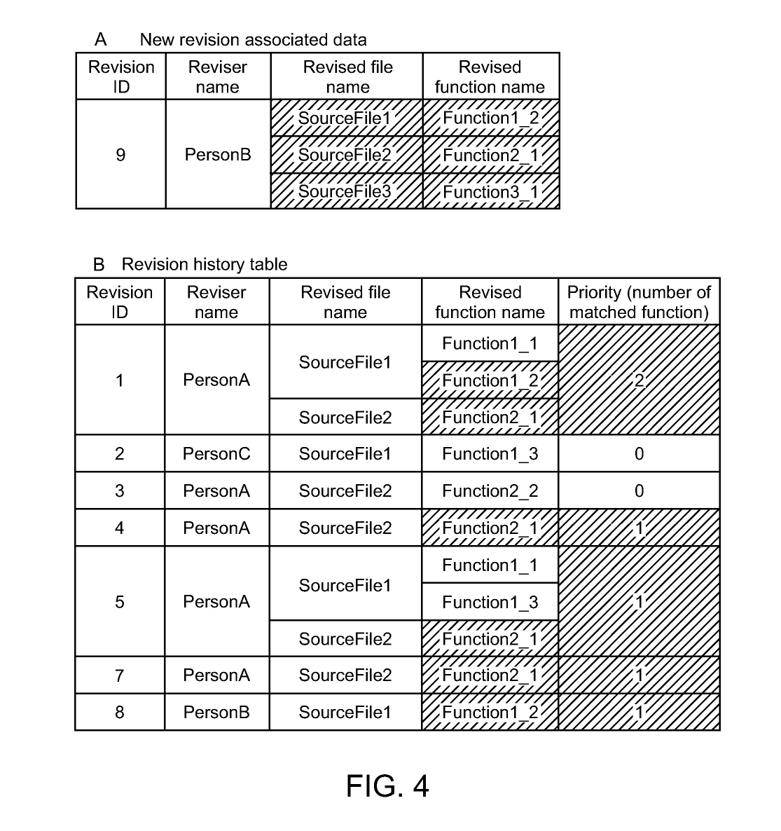

FIG. 4A shows one example of new revision associated data 235, and FIG. 4B shows one example of the revision history table 240 with the priority added. Seeing the new revision associated data 235 of FIG. 4A, three functions of Function1_2, Function2_1 and Function3_1 are revised due to new revision. Thus, the revision history table 240 of FIG. 4B is examined. For the past revision ID “1”, three functions of Function1_1, Function1_2 and Function2_1 are revised, in which the same functions as revised with the new revision ID “9” are two functions, Function1_2 and Function2_1. Therefore, the priority of the past revision ID “1” for the new revision ID “9” is 2.

On the other hand, in the past revision ID “5”, three functions are revised, like the past revision LD “1”, in which the same function as revised with the new revision ID “9” is one function, Function2_1. Therefore, the priority of the past revision ID “5” over the new revision ID “9” is 1. That is, the degree of overlapping the functions revised in the new revision is larger in the revision ID “1” than in the revision ID “5”, whereby the possibility of causing an error again due to new revision is stronger in the revision ID “1” and the priority over the new revision ID “9” is larger in the revision ID “1”.

The first weighting part 210 weights the specified function by determining whether or not the reviser of the function specified by the matched function name is different between the new revision and the past revision within the revision history table 240, if the count part 205 judges that the function name associated with the revision ID within the revision history table 240 and the function name within the new revision associated data 235 are matched. Specifically, the first weighting part 210 weights the specified function more heavily if the reviser of the function specified by the matched function name is different between the new revision and the past revision within the revision history table 240 than not different.

This method for weighting the priority of the past test case is based on the following inference. That is, the inference is that if the function already revised in the past is revised, the past test case for testing the past revision is likely to cause an error again due to new revision, but if the past revision is made by oneself, such possibility is lower than the past revision is made by others.

The weight for weighting by the first weighting part 210 may be an integer or decimal fraction as far as it is the positive number, and set by the user. When the weighting is made by the first weighting part 210, the count part 205 obtains the number of matched function names in consideration of the weighted result. As one example, the count part 205 multiplies the number of matched function names by the weight for weighting by the first weighting part 210. Each value obtained by the count part 205 is added as the priority of the test case for testing the revision of the corresponding revision ID to the revision history table 240 by the priority decision part 200.

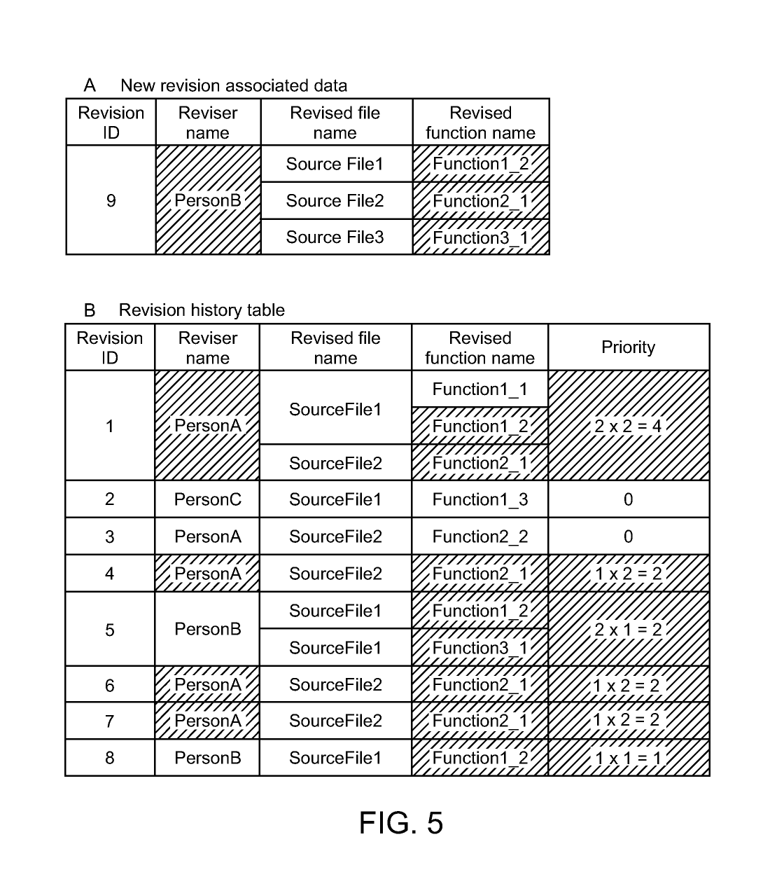

FIG. 5A shows one example of new revision associated data 235, and FIG. 5B shows one example of the revision history table 240 with the priority based on the weighted result added. In the example of FIG. 5, the weight in the case where the reviser is different is “2”, and the weight in the case where the reviser is the same is “1”. Seeing the new revision associated data 235 of FIG. 5A, the reviser of new revision is “PersonB” and three functions of Function1_2, Function2_1 and Function3_1 are revised. Thus, the revision history table 240 of FIG. 5B is examined. In the past revision ID “1”, the same functions as revised with the new revision ID “9” are two functions, Function1_2 and Function2_1, among the revised functions. Also, the reviser of the past revision ID “1” is “PersonA” who is different from the reviser of new revision, in which the weight for these functions is 2. Accordingly, the priority of the past revision ID “1” over the new revision ID “9” is 4, which is the number 2 of matched function names multiplied by the weight 2.

On the other hand, in the past revision ID “5”, the same functions as revised with the new revision ID “9” are two functions, Function1_2 and Function3_1, among the revised functions, as is the case with the past revision ID “1”. However, the reviser of the past revision ID “5” is “PersonB” who is the same as the reviser of new revision, in which the weight for these functions is 1. Accordingly, the priority of the past revision ID “5” over the new revision ID “9” is 2, which is the number 2 of matched function names multiplied by the weight 1.

That is, the degree of overlapping the functions revised in the new revision is the same in the revision ID “1” and the revision ID “5”. Taking notice of only this point, the possibility of causing an error again due to new revision is equivalent in the revision ID “1” and “5”. However, it is the reviser of new revision that made the revision with the revision ID. “5”, whereby the possibility of causing an error again due to new revision is low, and the priority over the new revision ID “9” in consideration of the reviser is larger in the revision ID “1”.

The first function risk table 245 is the table showing the amount of revision for the function revised in the new revision. Though the function is newly added by the revision in some cases, the first function risk table 245 does not include the newly added function, because it is considered that the newly added function has no influence on the past revision. The first function risk table creation part 280 creates the first function risk table 245 and temporarily stores it in the first storage part 230. Herein, temporarily storing means probably deleting the first function risk table 245 after being used by the second weighting part 215 as will be described later. The first function risk table 245 is created by the first function risk table creation part 280 in the following manner.

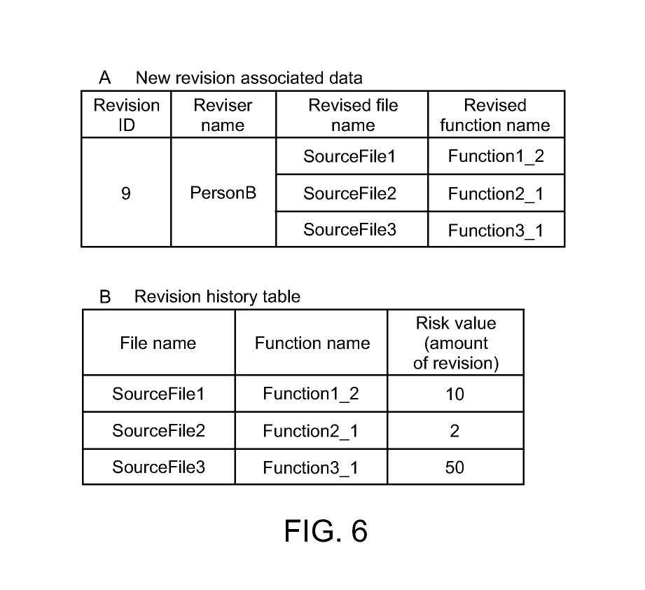

First of all, the first function risk table creation part 280 acquires the version of program corresponding to the new revision ID by referring to the correspondence table 260. Then, the first function risk table creation part 280 obtains the changed function name by referring to the new revision associated data 235. The first function risk table creation part 280 reads the source code of program in the acquired version and the source code of program in the previous version of the acquired version from the second storage part 255, compares the changed function between two versions, and finally obtains the amount of revision of interest. The amount of revision is a sum of the number of lines added to the function, the number of deleted lines and the number of changed lines. The addition, deletion and change of comments are excluded. FIG. 6A shows one example of new revision associated data 235, and FIG. 6B shows one example of the first function risk table 245.

The second weighting part 215 weights the specified function by determining whether or not the amount of revision in the new revision for the function specified by the matched function name is large by referring to the first function risk table 245, if the count part 205 judges that the function name associated with the past revision ID within the revision history table 240 and the function name within the new revision associated data 235 are matched. Specifically, the second weighting part 215 assigns a greater weight to the specified function in the case where the amount of revision in the new revision for the function specified by the matched function name is large than it is small.

This method for weighting the priority of the past test case is based on the following inference. That is, the inference is that if the function already revised in the past is revised, the test case for testing the past revision is likely to cause an error again due to new revision, but if the amount of revision due to new revision is small, the possibility that the test case for testing the past revision causes an error again due to new revision is low, even though the same function is revised in the past.

The weight for weighting by the second weighting part 215 may be a value that reflects the amount of revision, or the amount of revision itself. When the weighting is made by the second weighting part 215, the count part 205 obtains the number of matched function names in consideration of the weighted result. As one example, the count part 205 obtains the total value by adding the weights decided for the function if there is matched function name. Each obtained total value is appended as the priority of the test case for testing the revision of the corresponding revision ID to the revision history table 240 by the priority decision part 200.

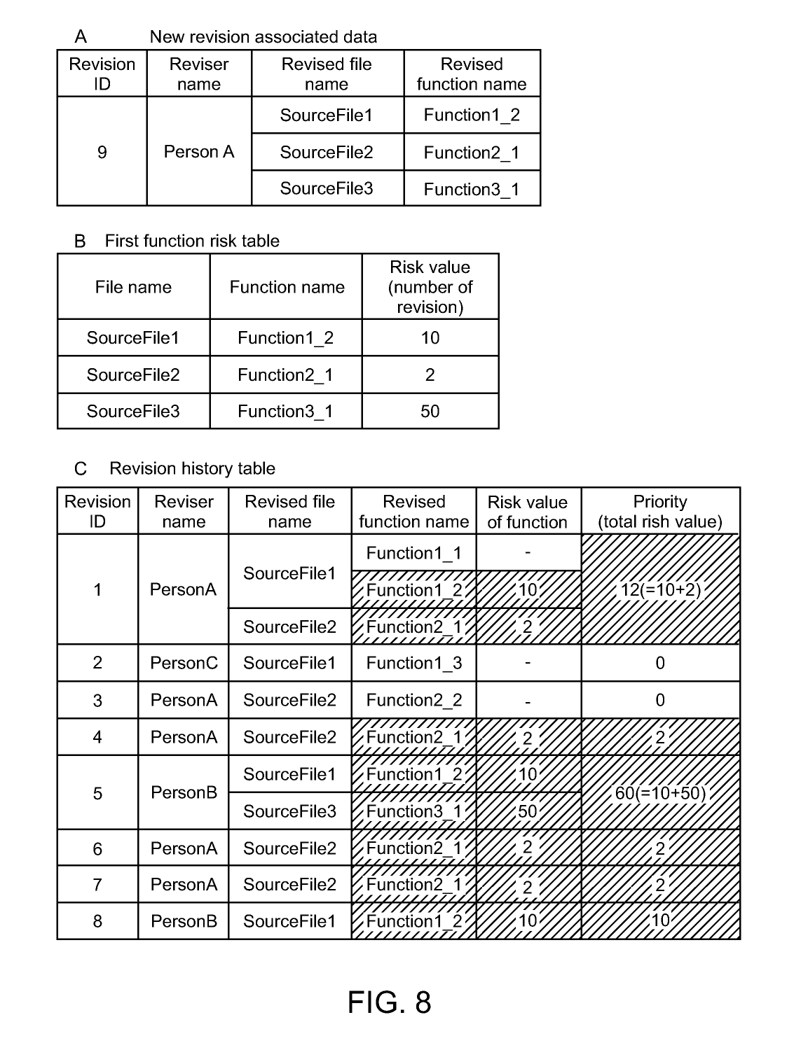

FIG. 8A shows one example of new revision associated data 235, FIG. 8B shows one example of the first function risk table 245, and FIG. 8C shows one example of the revision history table 240 with the priority based on the weighted result added. In the example of FIG. 8, the weight for weighting is the amount of revision itself for the function. As seen from the new revision associated data 235 of FIG. 8A, three functions of Function1_2. Function2_1 and Function3_1 are revised due to new revision. Therefore, these three functions are included in the first function risk table as shown in FIG. 8B.

Thus, the revision history table 240 of FIG. 8C is examined. For the past revision ID “1”, the same functions as revised with the new revision ID “9” are two functions, Function1_2 and Function2_1, among the revised functions. By the way, the risk values (amounts of revision) for these functions are 10 and 2. Accordingly, the priority of the past revision ID “1” over the new revision ID “99” is 12 by adding the weights 10 and 2 of the matched function names.

On the other hand, in the past revision ID “5”, the same functions as revised with the new revision ID “9” are two functions, Function1_2 and Function3_1, among the revised functions. By the way, the risk values (amounts of revision) for these functions are 10 and 50. Accordingly, the priority of the past revision ID “5” over the new revision ID “9” is 60 by adding the weights, 0 and 50 of the matched function names.

That is, the degree of overlapping the functions revised in the new revision is the same in the revision ID “1” and the revision ID “5”. Taking notice of only this point, the possibility of causing an error again due to new revision is equal in the revision ID “1” and “5”. However, the function Function3_1 having a large amount of revision in the new revision is revised with the revision ID “5”, besides the Function1_2, whereas the function Function2_1 having a small amount of revision in the new revision is revised with the revision ID “1”, besides the Function1_2. Therefore, the possibility that the test case associated with the revision ID “1” causes an error again due to new revision is low. Accordingly, in considering the amount of revision for the function due to new revision, the priority over the new revision ID “9” is larger with the revision ID “5”.

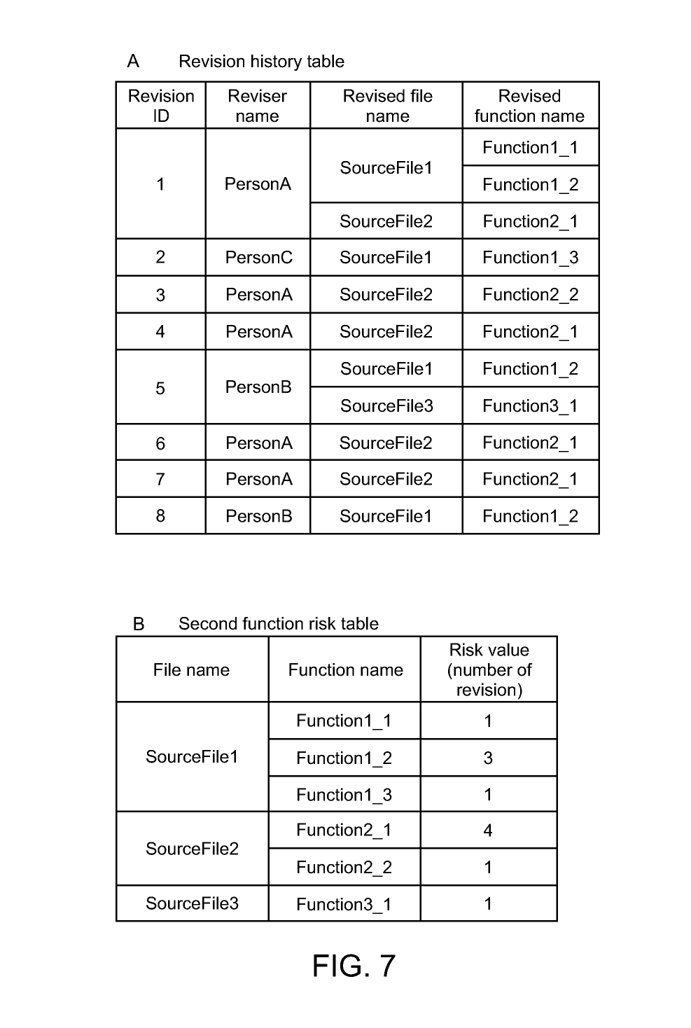

The second function risk table 250 is the table showing the number of revisions for the function revised in the past. The second function risk table creation part 285 creates the second function risk table 250 and temporarily stores it in the first storage part 230. Herein, temporarily storing means probably deleting the second function risk table after being used by the third weighting part 220 as will be described later. The second function risk table creation part 285 reads the revision history table 240 from the first storage part 230, and acquires the number of revisions by counting the number of times that each function appears in the revision history table 240. FIGS. 7A and 7B are examples of the revision history table 240 and the second function risk table 250.

The third weighting part 220 weights the specified function by determining whether or not the number of past revisions for the function specified by the matched function name is large by referring to the second function risk table 250, if the count part 205 judges that the function name associated with the past revision ID within the revision history table 240 and the function name within the new revision associated data 235 are matched. Specifically, the third weighting part 220 assigns a greater weight to the specified function in the case where the number of past revisions for the function specified by the matched function name is large than it is small.

This method for weighting the priority of the past test case is based on the following inference. That is, the inference is that if the function already revised in the past is revised, the test case for testing the past revision is likely to cause an error again due to new revision, and the possibility that the test case is an error is stronger as the number of past revisions for the function is greater.

The weight for weighting by the third weighting part 220 may be a value that reflects the number of revisions, or the number of revisions itself. When the weighting is made by the third weighting part 220, the count part 205 obtains the number of matched function names in consideration of the weighted result and decides the priority of the test case. As one example, the count part 205 obtains the total value by adding the weights decided for the functions if there are matched function names. Each decided priority is appended as the priority of the test case for testing the revision of the corresponding revision ID to the revision history table 240 by the priority decision part 200. The process by the third weighting part 220 and the count part 205 is the same as that by the second weighting part 215 and the count part 205 described with reference to FIG. 8, by using the second function risk table, instead of the first function risk table, and is not described by way of specific example.

The list creation part 290 reads the revision history table 240 with, the priority added from the first storage part 230 and creates a list by arranging the revision IDs according to priority.

As described above, with the information processing apparatus 100 according to the embodiment of the invention, the past test case to be carried out again is provided along with the priority from the relation with the new revision in the regression test of program. Therefore, even when there are many past test cases to be carried out, the past test case with high priority, or strong possibility of causing an error, can be examined preponderantly, and the problem that newly arises due to new revision can be found efficiently.

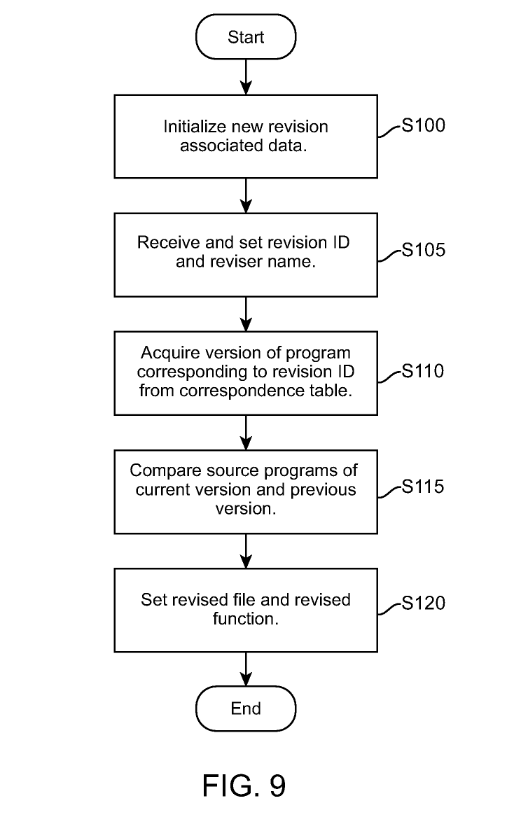

Referring to the flowcharts of FIGS. 9 to 15, the operation of each part of the information processing apparatus 100 according to this embodiment will be described below. FIG. 9 shows one example of processing flow in the new revision associated data acquisition part 270. The new revision associated, data acquisition part 270 first of all initializes the table of new revision associated data 235 as shown in FIG. 2A (step 100). The new revision associated data acquisition part 270 receives the new revision ID of specifying the new revision and the name of reviser making the new revision from the user via the input part of the information processing apparatus 100, and sets them in the table of revision associated data (step 105).

Next, the new revision associated data acquisition part 270 acquires the version of program corresponding to the new revision ID by referring to the version correspondence table 260 (step 110). The new revision associated data acquisition part 270 reads the source code in the previous version of the acquired version and the source code in the acquired version from the second storage part 255, and detects the unmatched function by comparing them (step 115). The new revision associated data acquisition part 270 sets all the function names of the detected unmatched functions and the file names of the files including the concerned functions in the table of new revision associated data 235 (step 120). The process is ended. In this manner, the new revision associated data 235 as shown in FIG. 2A is acquired.

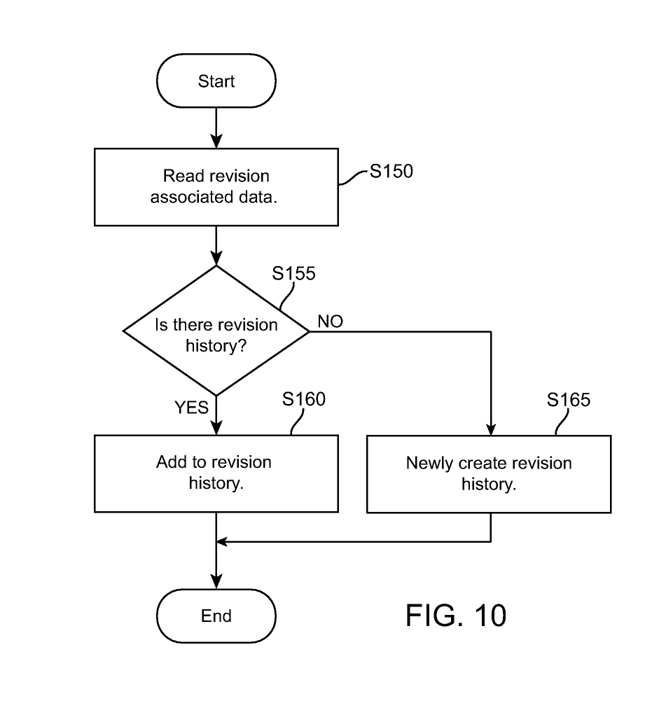

FIG. 10 shows one example of processing flow in the revision history creation/update part 275. The process is started by receiving a notification of acquiring the new revision associated data 235 from the new revision associated data acquisition part 270. The revision history creation/update part 275 first of all reads the new revision associated data 235 from the first storage part 230 (step 150). Next, the new revision associated data acquisition part 270 determines whether or not the revision history table 240 is already created (step 155). If the revision history table 240 already exists (step 155: YES), the new revision associated data 235 is added to the revision history table 240 (step 160). If the revision history table 240 does not exist (step 155: NO), the new revision associated data acquisition part 270 newly creates the revision history table 240 and saves the new revision associated data 235 in the revision history table 240 (step 165). The process is ended. In this manner, the revision history table 240 as shown in FIG. 3A is created.

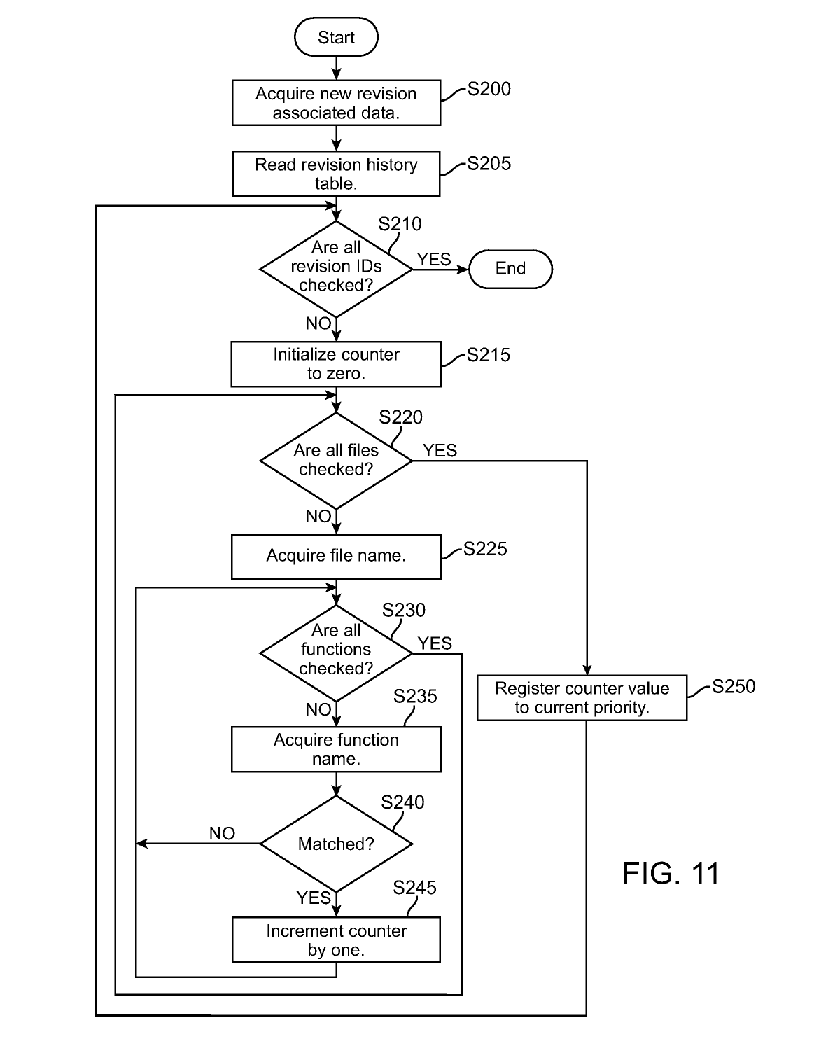

FIG. 11 shows one example of processing flow for deciding the priority in the count part 205. The count part 205 first of all reads the new revision associated data 235 and the revision history table 240 from the first storage part 230 (steps 200 and 205). And the count part 205 determines whether or not the priority is decided for every revision ID in the revision history table 240 (step 210). If there is any revision ID with the priority not decided (step 210: NO), the count part 205 acquires the next revision ID within the revision history table 240 to have the current revision ID, and initializes the counter to 0 (step 215).

Next, the count part 205 determines whether or not the file name is acquired for every file associated with the current revision ID (step 220). If there is any file name not acquired (step 220: NO), the count part 205 acquires the next file name within the revision history table 240 (step 225). The count part 205 further determines whether or not the function name is acquired for every function of acquired file name (step 230). If the function name is acquired for every function (step 230: YES), the process returns to step 220. If there is any function name not acquired (step 230: NO), the count part 205 acquires the next function name within the revision history table 240 (step 235). It is determined whether or not there is matched data by retrieving the new revision associated data 235 with the acquired file name and function name as the retrieval key (step 240).

If the matched data is found (step 240: YES), the counter is incremented by one (step 245). If the answer is NO at step 240, or if the matched data is not found, the process returns to step 230, or the process returns from step 245 to step 230. If the answer is YES at step 220, or if the file name is acquired for every file associated with the current revision ID, the current counter value is appended as the priority associated with the current revision ID to the revision history table 240 (step 250). The process returns to step 210. If the answer is YES at step 210, or if the priority is decided for every revision ID, the process is ended. In this manner, the revision history table 240 with the priority added as shown in FIG. 4B is completed.

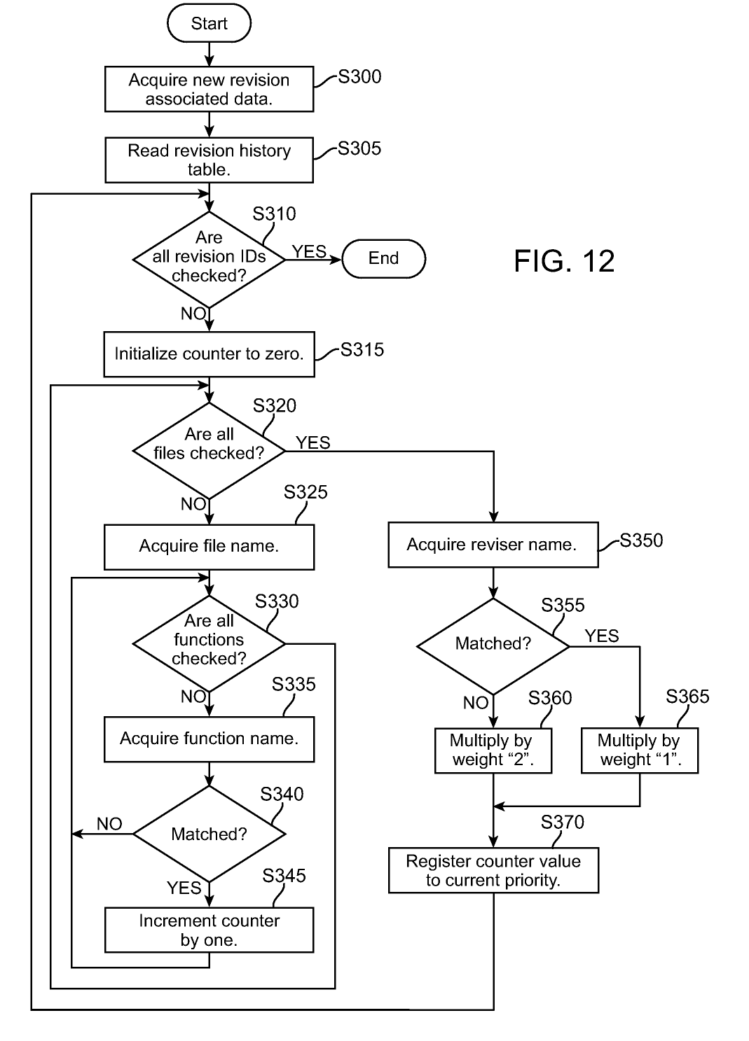

FIG. 12 shows one example of processing flow in the case where the count part 205 decides the priority in consideration of the weighted result by the first weighting part 210. As will be apparent from FIG. 12, a flowchart of FIG. 12 is the same as that of the process for deciding the priority without considering the weighted result as shown in FIG. 11, except for the process after checking all the files (from step 350 to step 365). Thus, the process after YES at step 320, or after checking all the files associated with the current revision ID, will be described below. The counter at the time of YES at step 320 indicates the number of functions having the function name matched with the function name included in the new revision associated data 235 among the functions associated with the current revision ID.

If the count part 205 ends checking all the files associated with the current revision ID and counting the number of the matched function names, the first weighting part 210 acquires the reviser name associated with the current revision ID from the revision history table 240 (step 350). The first weighting part 210 determines whether or not the acquired reviser name is matched with the reviser name included in the new revision associated data 235 (step 355). If unmatched (step 355: NO), the first weighting part 210 multiplies the counter by a positive weight value (e.g., “2”) above 1 that is preset by the user, and substitutes the value into the counter (step 360).

If the answer is YES at step 355, or if the reviser name is matched, the first weighting part 210 multiplies the counter by a positive weight value of 1 or less (e.g., “1”) preset by the user, and substitutes the value into the counter (step 365). The process proceeds from step 360 or 365 to step 370, where the priority decision part 200 appends the current counter value as the priority associated with the current revision ID to the revision history table 240. The process returns to step 310. If the answer is YES at step 310, or if the priority is decided for every revision ID, the process is ended. In this manner, the revision history table including the priority in consideration of weighting by the reviser as shown in FIG. 5B is completed.

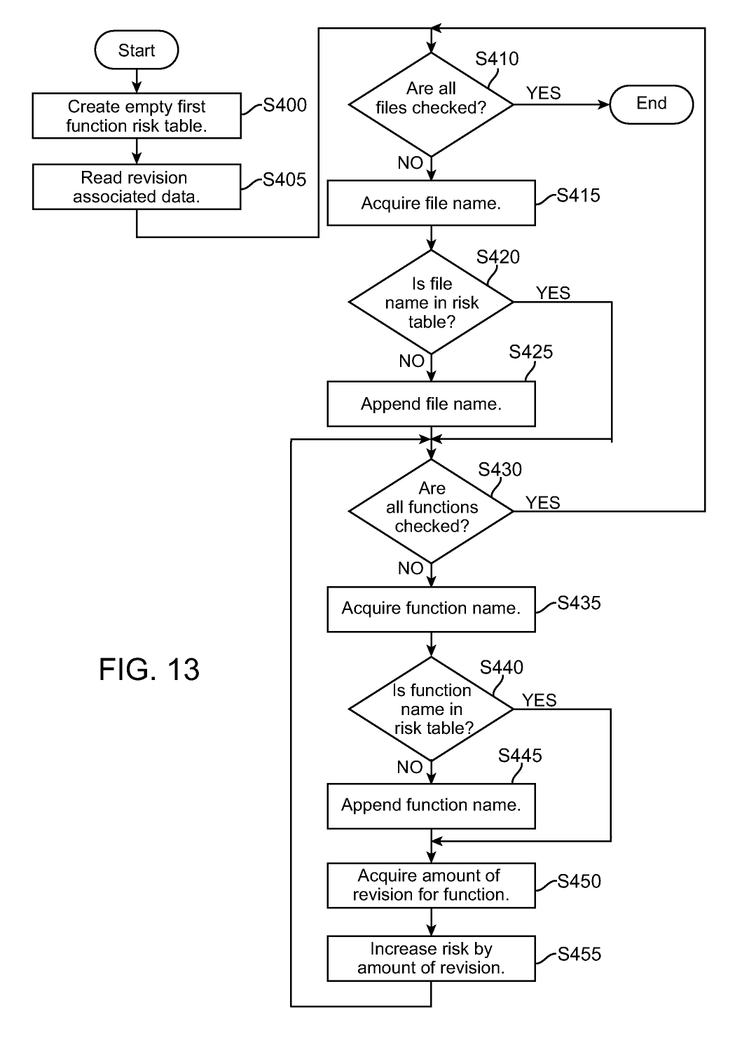

FIG. 13 shows one example of processing flow in the first function risk table creation part 280. The first function risk table creation part 280 first of all creates an empty first function risk table (step 400). The first function risk table creation part 280 reads the new revision associated data 235 from the first storage part 230 (step 405), and determines whether or not the file name is acquired for every file in the new revision associated data 235 (step 410). If there is no file name not acquired (step 410: YES), the process is ended. If there is any file name not acquired (step 410: NO), the first function risk table creation part 280 acquires the next file name within the new revision associated data 235 (step 415). The first function risk table creation part 280 determines whether or not the acquired file name exists in the first function risk table (step 420). If not (step 420: NO), the file name is appended to the first function risk table (step 425).

If the answer is YES at step 420, or if the acquired file name is in the first function risk table, the process goes to step 430, or the process proceeds from step 425 to step 430, where the first function risk table creation part 280 further determines whether or not the function name is acquired for every function of the acquired file name. If there is no function name not acquired (step 430: YES), the process returns to step 410. If there is any function name not acquired (step 430: NO), the first function risk table creation part 280 acquires the next function name within the new revision associated data 235 (step 435). The first function risk table creation part 280 determines whether or not the acquired function name exists in the first function risk table (step 440). If not (step 440: NO), the function name is appended to the first function risk table (step 445).

If the answer is YES at step 440, or if the function name is in the first function risk table, the process goes to step 450, or the process proceeds from step 445 to step 450, where the first function risk table creation part 280 obtains the amount of revision due to new revision for the function with the acquired function name. The amount of revision is obtained by comparing the function after revision due to new revision and the function before revision. The first function risk table creation part 280 sets the acquired amount of revision as the risk associated with the current function name in the first function risk table creation part 280 (step 455). The process returns to step 430. In this manner, the first function risk table as shown in FIG. 6B is completed.

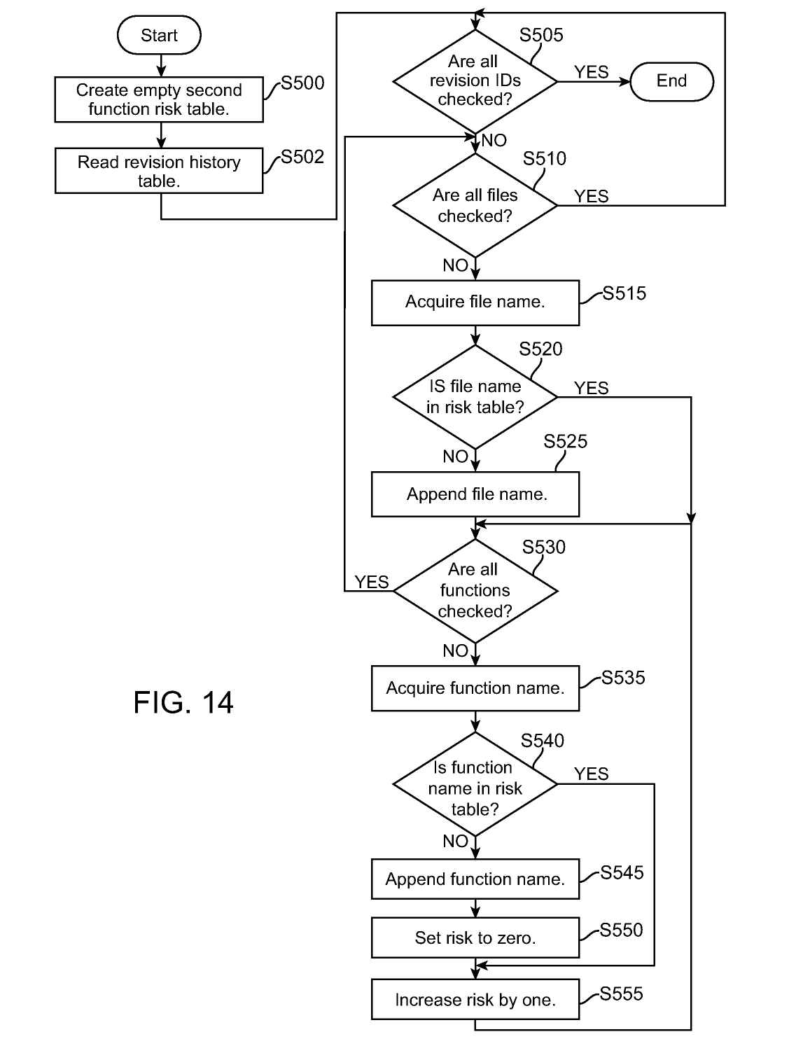

FIG. 14 shows one example of processing flow in the second function risk table creation part 285. The second function risk table creation part 285 first of all creates an empty second function risk table (step 500). The second function risk table creation part 285 reads the revision history table 240 from the first storage part 230 (step 502), and determines whether or not every revision ID in the revision history table 240 is checked (step 505). If checking every revision ID is ended (step 505: YES), the process is ended. If there is any revision ID not checked (step 505: NO), the second function risk table creation part 285 acquires the next revision ID within the revision history table 240 to have the current revision ID, and determines whether or not the file name is acquired for every file associated with the current revision ID (step 510). If there is no file name not acquired (step 510: YES), the process returns to step 505.

If there is any file name not acquired (step 510: NO), the second function risk table creation part 285 acquires the next file name within the revision history table 240 (step 515). And the second function risk table creation part 285 determines whether or not the acquired file name exists in the second function risk table (step 520). If not (step 520: NO), the file name is appended to the second function risk table (step 525). If the answer is YES at step 520, or if the acquired file name is in the first function risk table, the process goes to step 530, or the process proceeds from step 525 to step 530, where the second function risk table creation part 285 further determines whether or not the function name is acquired for every function of the acquired file name. If there is no function name not acquired (step 530: YES), the process returns to step 510.

If there is any function name not acquired (step 530: NO), the second function risk table creation part 285 acquires the next function name within the revision history table 240 (step 535). The second function risk table creation part 285 determines whether or not the acquired function name exists in the second function risk table (step 540). If not (step 540: NO), the function name is appended to the second function risk table (step 545). Then, the second function risk table creation part 285 sets the value of risk associated with the current function name to 0 (step 550). If the answer is YES at step 540, or if the function name is in the second function risk table, the process goes to step 555, or the process proceeds from step 550 to step 555, where the second function risk table creation part 285 increments the value of risk associated with the current function name by one. The process returns to step 530. In this manner, the second function risk table as shown in FIG. 7B is completed.

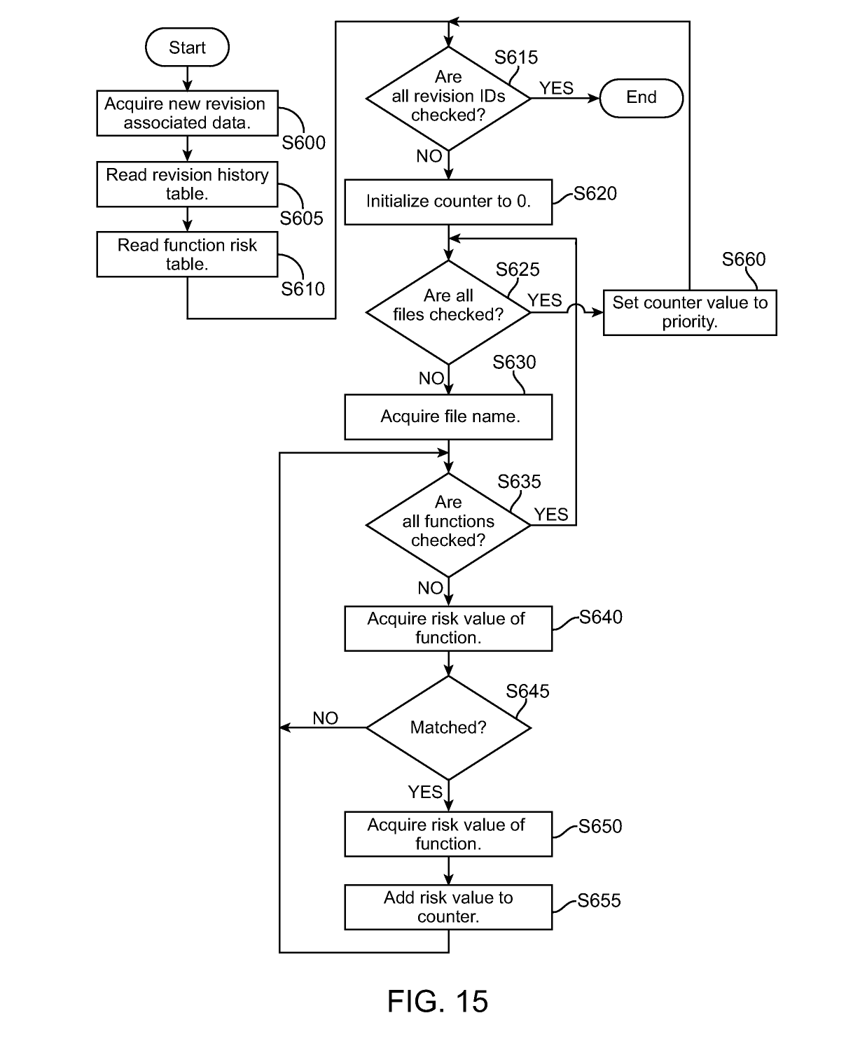

FIG. 15 shows one example of processing flow in the case where the count part 205 decides the priority in consideration of the weighted result by the second weighting part 215. As will be apparent from FIG. 15, the flowchart from step 600 to step 645 as shown in FIG. 15 is the same as the process for deciding the priority without considering the weighted result as shown in FIG. 11, except for step 610 of reading the first function risk table in the beginning. Thus, the process after step 645, or the process after retrieving the new revision associated data 235 with the file name and function name acquired from the revision history table 240 as the retrieval key and determining whether or not there is matched data will be described below.

If the count part 205 determines that data matched with the acquired file name and function name exists in the new revision associated data 235 (step 645: YES), the second weighting part 215 acquires the risk value of the function with the matched function name by referring to the first function risk table (step 650). The count part adds the risk value acquired by the second weighting part 215 to the counter (step 655). The process returns to step 635. At step 635, if it is determined that the function name is acquired for every function of the acquired file name, the process returns to step 625. Further, at step 625, if it is determined that the file name is acquired for every file associated with the current revision ID, the process goes to step 660. The priority decision part 200 appends the current counter value, or the sum of risk values of the functions of the matched function names as the priority associated with the current revision ID to the revision history table 240.

In this manner, the revision history table including the priority in consideration of weighting due to the amount of revision for the function as shown in FIG. 8C is completed. The process for deciding the priority in consideration of the weighted result by the third weighting part 220 is the fundamentally the same as the process as shown in FIG. 15, except for the use of the second function risk table, instead of the first function risk table, and is not described in detail here.

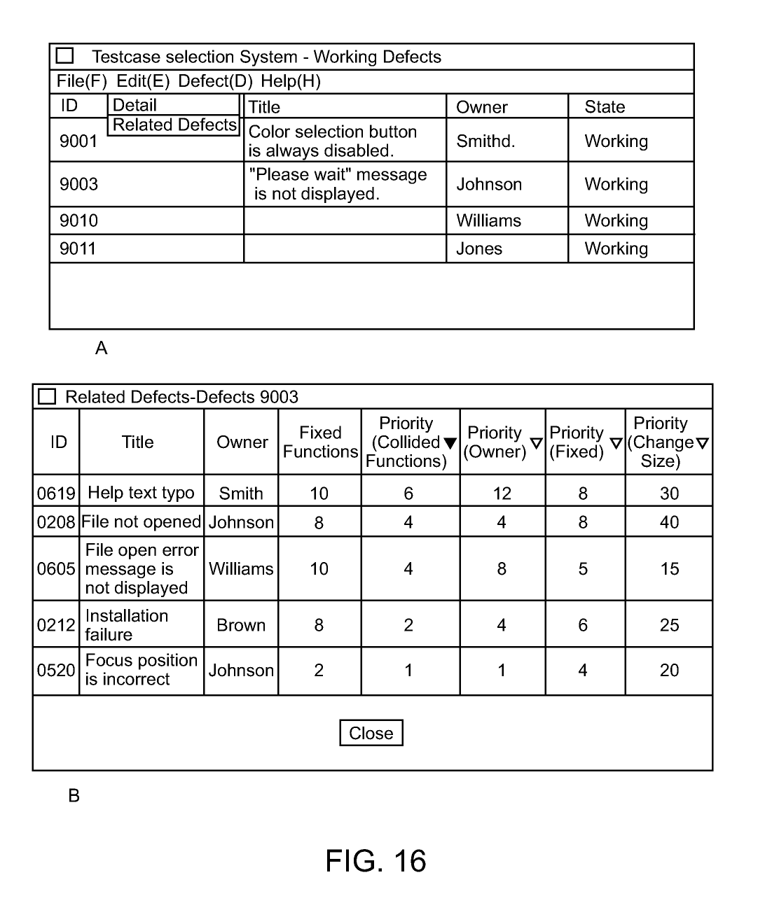

FIG. 16 shows one example of a dialog box of a list created by the list creation part 290. FIG. 16A is the dialog box of the new revision list, in which one entry includes the revision ID, Title that is a summary of revision factor, Owner indicating the reviser, and State indicating the current working situation. Herein, one new revision is selected (revision ID “9003” in FIG. 16A), “Related Defects” is selected from the “Defect (D)” menu in this state and clicked using an input device such as a mouse, so that the dialog box as shown in FIG. 16B is displayed on the screen of the display device in the information processing apparatus 100.

FIG. 16B shows one example of a list of past revision ID list associated with the revision ID “9003”. One entry of the list of past revision ID includes the revision ID, Title of revision and Owner of revision, like the list of FIG. 16A, and further includes the following five items; Fixed Functions indicating the number of revised functions due to the revision, Priority (Collided Functions) indicating the priority in terms of the number of matched functions, Priority (Owner) indicating the priority in consideration of weighting by the reviser, Priority (Fixes) indicating the priority in consideration of weighting by the number of revision, and Priority (Changed Size) indicating the priority in consideration of weighting by the amount of revision.

On the dialog box of FIG. 16B, the revision IDs are sorted and listed in the order of priority in terms of the number of matched functions. When it is desired that the revision IDs are sorted in the other order of priority, the revision IDs are sorted in the order of priority by clicking an indication of “V” on each item name (e.g., Priority (Owner)) using an input device such as a mouse. The list creation part 290 creates this list by reading the revision history table 240 with the priority added as shown in FIG. 4B, FIG. 5B and FIG. 8C from the first storage part 230 and referring to it.

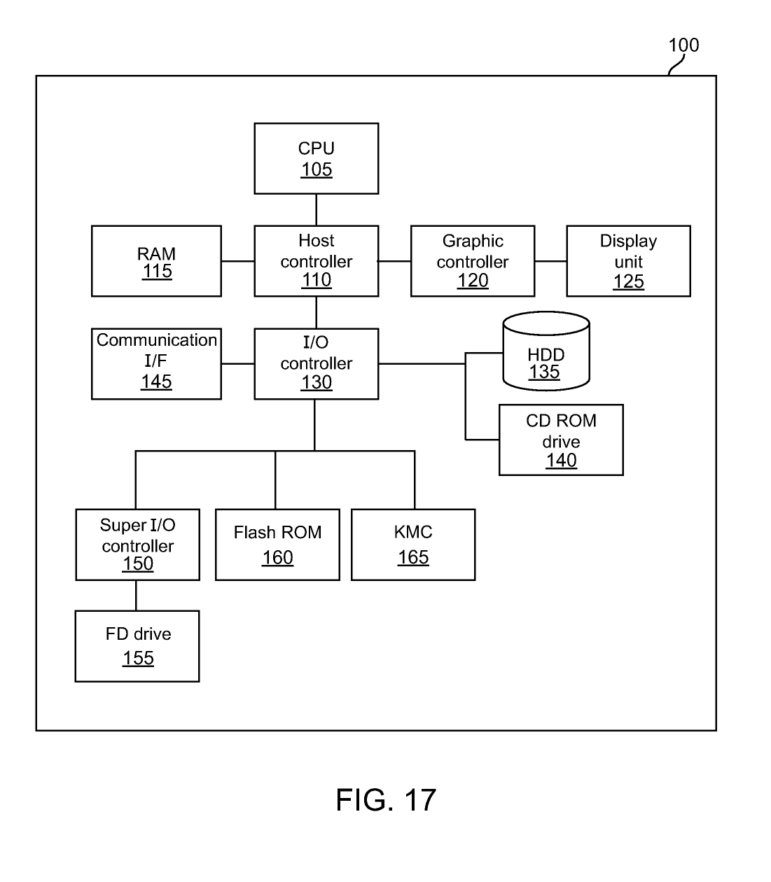

FIG. 17 shows one example of the hardware configuration of the information processing apparatus 100 according to this embodiment of the invention. The information processing apparatus 100 comprises a CPU peripheral part having a CPU 105 and a RAM 115 connected with each other by a host controller 10, an input/output part having a communication interface 145, a hard disk drive 135 and a CD-ROM drive 140 that are connected to the host controller 110 via an input/output controller 130, and a legacy input/output part having a super I/O controller 150 connected to the input/output controller 130 and a flexible disk drive 155, a flash ROM 160 and a keyboard mouse controller 165 connected to the super I/O controller 150.

The host controller 110 connects the CPU 105 gaining access to the RAM 115 at a high transfer rate to the RAM 115. The CPU 105 operates based on a program stored in the hard disk to control each part. The program for deciding the priority of test case to be carried out according to the embodiment of the invention is stored in the hard disk, and executed using the RAM 115 by the CPU 105. The program enables the information processing apparatus 100 to function as the priority decision part 200 including the count part 205, the first weighting part 210, the second weighting part 215 and the third weighting part 225, the first storage part 230 that stores the new revision associated data 235, the revision history table 240, the first function risk table 245 and the second function risk table 250, and the second storage part 255 that stores the version correspondence table 260 and the source code 265 of program in each version.

The, program further, enables the information processing apparatus 100 to function as the new revision associated data acquisition part 270, the revision history creation/update part 275, the first function risk table creation part 280, the second function risk table creation part 285, and the list creation/output part 290. The specific function and operation are the same as described using FIGS. 1 to 15, and not described here. The program can be stored in a readable medium for the information processing apparatus 100.

The readable medium for the information processing apparatus may be arbitrary unit containing the program or relevant program for use in an instruction execution system, device or apparatus, and capable of storing, communicating, propagating or conveying the program. The medium may be an electronic, magnetic, optical, electromagnetic, infrared, or semiconductor system (or device or apparatus), or a propagation medium. Examples of the readable medium for the information processing apparatus include a semiconductor or solid-state storage device, a magnetic tape, a removable information processing apparatus/diskette, a random access memory (RAM), a read only memory (ROM), a rigid magnetic disk and an optical disk. Example of the optical disk at the present time include a compact disk read only memory (CD-ROM), a compact disk read/write (CD-R/W) and a DVD.

Also, the input/output controller 130 connects the communication interface 145 that is a relatively high speed input/output device, the hard disk drive 135 and the CD-ROM drive 140 to the host controller 110. The communication interface 135 enables the communications via a network with an external apparatus.

Also, the input/output controller 130 is connected to the relatively slow input/output devices such as the super I/O controller 150 and the keyboard mouse controller 165, and the flash ROM 160. The flash ROM 160 stores a boot program executed by the CPU 105 at the time of booting up the information processing apparatus 100 and the programs dependent on the hardware of the information processing apparatus 100. The flexible disk drive 155 reads the program or data from the flexible disk and provides it via the RAM 115 to the super I/O controller 150. The super I/O controller 150 connects the flexible disk, and various input/output devices via a parallel port, a serial port, a keyboard port, or a mouse port, for example.

While the present invention has been described above in connection with the embodiment, the technical scope of the invention is not limited to the scope described in the embodiment. For example, the weighting in deciding,the priority is any one of the weighting by the reviser, weighting by the amount of revision due to new revision for the function, and weighting by the number of revisions due to past revision for the function in the above embodiment. However, a combination of the above methods of weighting is also possible. As an example, the weighting by the amount of revision due to new revision for the function and the weighting by the reviser may be combined. For example, suppose that there are two or more functions matched with the certain past revision ID, and the reviser is different from the reviser of new revision. In this case, the priority of the concerned revision ID can be obtained by multiplying the total amount of revision for the matched functions due to new revision by the weight value in which the reviser is different.

Also, though the reviser is decided for each revision ID in the above description, the reviser may be alternatively decided for each function or each file. In this case, the priority of the revision ID is a sum of weight values decided by the revisers of the matched functions. In this manner, it will be apparent to those skilled in the art that various changes or improvements may be made to the above embodiment. Accordingly, such changes or improvements may be also naturally included in the technical scope of the invention.

What is claimed is:

1. A method for deciding the priority of a test case to be carried out in a regression test of a program including one or more functions in an information processing apparatus, said method comprising:
reading a revision history table from a storage part of said information processing apparatus, said revision history table associating each of a plurality of first revision identifiers, which identifies the past revision, with one or more first function identifiers each of which identifies said function revised in said past revision identified by said associated first revision identifier;
acquiring one or more second function identifiers each of which identifies said function revised in the new revision;
obtaining, for each of said first revision identifiers in said revision history table, the number of matched function identifiers between said one or more first function identifiers associated with said first revision identifier and said acquired one or more second function identifiers; and
deciding the priority of the test case for testing the past revision identified by said first revision identifier to said new revision based on said obtained number of matched function identifiers for each of said first revision identifiers in said revision history table.

2. The method according to claim 1, wherein said acquiring said one or more second function identifiers comprises acquiring said one or more second function identifiers via an input part of said information processing apparatus.

3. The method according to claim 1, wherein said acquiring the one or more second function identifiers comprises accepting a second revision identifier for identifying said new revision via an input part of said information processing apparatus, and detecting the unmatched function by comparing a source code of said program in a version associated with said second revision identifier and a source code of said program in a previous version of said version to acquire said one or more second function identifiers.

4. The method according to claim 1, wherein said obtaining the number of matched function identifiers further comprises weighting a matched function identified by said matched function identifier by determining whether or not a reviser of said matched function is different between said new revision and said past revision to obtain the number of matched function identifiers in consideration of the weighted result.

5. The method according to claim 4, wherein said matched function of which said reviser is different between said new revision and said past revision is more heavily weighted than said matched function of which said reviser is not different.

6. The method according to claim 1, wherein said obtaining the number of matched function identifiers further comprises weighting a matched function identified by said matched function identifier according to the amount of revision due to said new revision for said matched function to obtain the number of matched function identifiers in consideration of the weighted result.

7. The method according to claim 6, wherein said matched function for which the amount of revision due to said new revision is large is more heavily weighted than said matched function for which said amount of revision is small.

8. The method according to claim 1, wherein said obtaining the number of matched function identifiers further comprises weighting a matched function identified by said matched function identifier according to the number of past revisions for the matched function to decide said priority by obtaining the number of matched function identifiers in consideration of the weighted result.

9. The method according to claim 8, wherein said matched function for which said number of past revisions is large is more heavily weighted than said matched function for which said number of past revisions is small.

10. The method according to claim 1, further comprising outputting a list of said first revision identifiers in which said first revision identifiers are arranged in said decided order of priority via an output part:of said information processing apparatus.

11. An information processing apparatus for deciding the priority of a test case to be carried out in a regression test of a program including one or more functions, comprising:
a storage part for storing a revision history table that associates each of a plurality of first revision identifiers, which identifies the past revision, with one or more first function identifiers each of which identifies said function revised in said past revision identified by said associated first revision identifier;
an acquisition part for acquiring one or more second function identifiers each of which identifies said function revised in the new revision; and
a priority decision part for obtaining, for each of said first revision identifiers in said revision history table read from said storage part, the number of matched function identifiers between said one or more first function identifiers associated with said first revision identifier and said acquired one or more second function identifiers and deciding the priority of said test case for testing the past revision identified by said first revision identifier to said new revision based, on said obtained number of matched function identifiers for each of said first revision identifiers in said revision history table.

12. A program for deciding the priority of a test case to be carried out in a regression test of a program including one or more functions, said program enabling an information processing apparatus to perform:
reading a revision history table from a storage part of said information processing apparatus, said revision history table associating each of a plurality of first revision identifiers, which identifies the past revision, with one or more first function identifiers each of which identifies said function revised in said past revision identified by said associated first revision identifier;
acquiring one or more second function identifiers each of which identifies said function revised in the new revision;
obtaining, for each of said first revision identifiers in said revision history table, the number of matched function identifiers between said one or more first function identifiers associated with said first revision identifier and said acquired one or more second function identifiers; and
deciding the priority of the test case for testing the past revision identified by said first revision identifier to said new revision based on said obtained number of matched function identifiers for each of said first revision identifiers in said revision history table.
